(19) United States
(12) Patent Application Publication
(10) Pub. No.: US 2024/0210727 A1
(43) Pub. Date: Jun. 27, 2024

(54) OPHTHALMIC ARTICLES MADE FROM CELLULOSE ESTER COMPOSITIONS HAVING HIGH TOUGHNESS AND DIMENSIONAL STABILITY

(71) Applicant: Eastman Chemical Company, Kingsport, TN (US)

(72) Inventors: Derrick Scott Torres, Kingsport, TN (US); Thomas Joseph Pecorini, Kingsport, TN (US); Lea Clayton Paslay, III, Jonesborough, TN (US); Haining An, San Jose, CA (US); Naixiong Jin, Foster City, CA (US)

(73) Assignee: Eastman Chemical Company, Kingsport, TN (US)

(21) Appl. No.: 18/553,740

(22) PCT Filed: Mar. 29, 2022
(86) PCT No.: PCT/US2022/022265

§ 371 Date: Oct. 3, 2023

Related U.S. Application Data
(60) Provisional application No. 63/172,292, filed on Apr. 8, 2021.

(51) Int. Cl. G02C 5/00; B29D 12/02; C08K 5/12; C08L 1/08

(52) U.S. Cl. CPC G02C 5/008; B29D 12/02; C08K 5/12; C08L 1/08

(57) ABSTRACT

Ophthalmic articles made from a cellulose ester composition is provided, the cellulose ester composition comprising at least one cellulose ester and at least one hexanedioate plasticizer in amounts to provide an ophthalmic article having a high glass transition temperature and dimensional stability.

### FIELD OF THE INVENTION

This invention belongs to the field of molded plastic articles suitable for ophthalmic applications, such as eyeglass and sunglass frames. Aspects of cellulose ester chemistry, particularly to cellulose esters comprising plasticizers are also provided.

### BACKGROUND OF THE INVENTION

Ophthalmic articles, such as eyeglass frames, need good toughness to withstand everyday abuse, flexibility to permit a comfortable fit, and creep resistance to prevent deformation during high-humidity/high-temp shipping environments. Cellulose esters have been used for eyeglass frames for many years due to their ability to meet these criteria. Commercially available cellulose esters that are melt processed into ophthalmic articles typically contain significant amounts of monomeric plasticizer to allow for processing and to impart sufficient toughness to the molded article. However, the addition of high levels of monomeric plasticizer has drawbacks, as they will decrease the HDT relative to the base cellulose ester and limit the use of the cellulose ester materials for applications that can accommodate an HDT below about 90° C. High levels of monomeric plasticizer in cellulose esters can also cause the molded eyeglass frames to deform and distort due to the high temperatures encountered in warehouses and shipping containers. Also, common monomeric plasticizers used in cellulose ester molded articles can experience unacceptable plasticizer exudation during processing and use.

It would be beneficial to ophthalmic applications if melt processable cellulose ester compositions could be identified that did not have such drawbacks.

### BRIEF SUMMARY OF THE INVENTION

Materials used for ophthalmic applications such as eyeglass and sunglass frames require a balance of relatively high Tg (or HDT), high toughness (e.g., high notched izod impact), and high dimension stability (i.e., low creep deflection), especially when molded into thin parts. Surprisingly, it has been discovered that compositions of cellulose esters, including cellulose acetate (CA), can be prepared with glass transition temperatures (Tg's) of about 120° C., or 125° C., or higher, and have good clarity, dimensional stability and toughness. In embodiments of this invention, this can be achieved by reducing the amount of conventional monomeric plasticizers in the compositions. However, reducing the monomeric plasticizer can decrease the toughness of these high Tg cellulosic compositions. Surprisingly, it has been found that certain combinations of CA and hexanedioate plasticizer, can restore the toughness of high Tg cellulosic compositions, and provide a cellulose ester composition with good flow properties and good clarity that is suitable for higher temperature applications and that maintains long term dimensional stability.

Plasticized cellulose acetate (CA) compositions used in the eyewear market typically have low pressure heat deflection temperatures (LoHDTs) less than 90° C. This is because commercially-available CA utilized in melt processing and the forming of articles typically contain significant amounts of plasticizer to allow for processing and to impart toughness to the molded article. Although plasticized cellulose-ester products can be prepared having LoHDTs exceeding 90° C., it is generally achieved by reducing the amount of plasticizer in the composition. However, a reduction in plasticizer leads to a reduction in the toughness of the molded article. It would be beneficial to provide polymer-based resins derived from cellulose that can be melt processed, exhibit excellent toughness, and have a LoHDT higher than 90° C.

In certain embodiments, this invention relates to ophthalmic articles made from a dispersion of one or more hexanedioate plasticizers into cellulose ester compositions, in amounts sufficient to improve the mechanical and physical properties of the cellulose ester compositions. The hexanedioate plasticized cellulose esters, according to embodiments of the invention, have the unique properties of being melt processable, having significantly higher Tg's relative to typical plasticized cellulose ester thermoplastics, have high modulus, good impact properties, and good resistance to deformation under load.

In one embodiment of the invention, ophthalmic articles made from a cellulose ester composition is provided, the composition comprising at least one cellulose ester and at least one hexanedioate plasticizer in an amount from 10 to less than 22 wt %, based on the total weight of the cellulose ester composition. In one embodiment, the cellulose ester is chosen from cellulose acetate containing from about 10 to about 40% by weight acetyl, based on the total weight of the polymer and the cellulose ester composition has a Tg of at least 120° C. In one embodiment, the cellulose ester is chosen from cellulose acetate containing from about 10 to about 40% by weight acetyl, based on the total weight of the polymer, and has a Mw of 85,000 to 100,000 (measured as discussed herein). In embodiments, the cellulose ester composition has a LoHDT of 90° C. or higher, or at least 92° C., or at least 95° C.

In another embodiment of the invention, a cellulose ester composition is provided which comprises at least one cellulose ester, and at least one hexanedioate plasticizer in an amount from 10 to less than 19 wt % and comprises at least one monomeric plasticizer in an amount from 2 to 10 wt %, based on the total weight of the cellulose ester composition.

In another embodiment of the invention, a process for producing the cellulose ester composition is provided comprising contacting at least one cellulose ester, at least one hexanedioate plasticizer, and (optionally) at least one monomeric plasticizer, and mixing the combination. In one embodiment, the cellulose ester composition includes a monomeric plasticizer that is present in an amount that does not substantially reduce the Tg of the cellulose ester composition compared to a similar composition without the monomeric plasticizer. In embodiments, the Tg does not change (e.g., reduce) more than 10%, or 5%, or 2%, as a result of including the monomeric plasticizer.

In embodiments of the invention, cellulose ester compositions are described that contain none to less than 1 wt % monomeric plasticizer, but contain 19 wt % to less than 22 wt %, or 20 wt % to less than 22 wt %, or greater than 20 to less than 22 wt %, hexanedioate plasticizer, based on the total weight of the cellulose ester composition, and have Tg values greater than 120° C., notched Izod impact strength values greater than 150, or 160, or 170, or 180, or 190 J/m at 23° C., and creep deflection or less than 10, or less than 9.5, or less than 9.0 mm.

In certain embodiments, the cellulose ester resin is chosen from at least one cellulose acetate (CA), cellulose propionate (CP), cellulose butyrate (CB), cellulose acetate propionate (CAP), cellulose acetate butyrate (CAB), cellulose acetate iso-butyrate (CAIB), cellulose propionate butyrate (CPB), cellulose tripropionate (CTP), or cellulose tributyrate (CTB). In certain embodiments, the resin contains less than 25, or less than 20, or less than 15, or less than 10, or less than 5 wt %, or none, of any other polymer(s) that contribute to the continuous binder phase of the resin with the cellulose ester. For example, in certain embodiments, the hexanedioate plasticizer is present as a dispersed phase within the cellulose ester resin and does not contribute to the continuous binder phase of the resin with the cellulose ester.

In certain embodiments, the cellulose ester resin is chosen from at least one cellulose acetate (CA), cellulose propionate (CP), cellulose butyrate (CB), cellulose acetate propionate (CAP), cellulose acetate butyrate (CAB), cellulose acetate iso-butyrate (CAIB), cellulose propionate butyrate (CPB), cellulose tripropionate (CTP), or cellulose tributyrate (CTB), and the hexanedioate is miscible in the cellulose ester resin, or in the same phase as the cellulose ester binder phase.

In embodiments, the hexanedioate plasticizer and monomeric plasticizer are present in amount sufficient to provide a composition capable of molding and having a balance of relatively high Tg, good toughness, and resistance to creep (i.e., deformation under load). In embodiments, the cellulose ester is CA, the hexanedioate plasticizer comprises a benzyl hexanedioate, and the monomeric plasticizer is an adipate or phthalate based monomeric plasticizer, e.g., dioctyl adipate (DOA) or diethyl phthalate (DEP), and the composition comprises 10 to 19 wt %, or 10 to less than 19 wt % hexanedioate plasticizer; and 2 to less than 10 wt % monomeric plasticizer. In one embodiment, the monomeric plasticizer is DEP.

In certain embodiments, for any of the embodiments described herein, the one or more hexanedioate plasticizer can comprise benzyl 2-(2-methoxyethoxy)ethyl hexanedioate, bis[2-(2-methoxyethoxy)ethyl] hexanedioate, dibenzyl hexanedioate, or combinations thereof.

In certain embodiments, for any of the embodiments described herein, the one or more hexanedioate plasticizers comprises benzyl 2-(2-methoxyethoxy)ethyl hexanedioate in an amount of less than 50 wt %, or 40 wt % or less, or 30 wt % or less, or 20 wt % or less, or 10 wt % or less, or 5 wt % or less, based on the total weight of all the hexanedioate plasticizers. In one embodiment, the one or more hexanedioate plasticizers (and the cellulose ester resin) does not contain any benzyl 2-(2-methoxyethoxy)ethyl hexanedioate.

In certain embodiments, for any of the embodiments described herein, the one or more hexanedioate plasticizers comprises bis[2-(2-methoxyethoxy)ethyl] hexanedioate in an amount of 50 wt % or more, or 60 wt % or more, or 70 wt % or more, or 80 wt % or more, or 90 wt % or more, or 95 wt % or more, based on the total weight of all the hexanedioate plasticizers. In one embodiment, the one or more hexanedioate plasticizers is bis[2-(2-methoxyethoxy)ethyl] hexanedioate.

In certain embodiments, for any of the embodiments described herein, the one or more hexanedioate plasticizers comprises dibenzyl hexanedioate in an amount of 50 wt % or more, or 60 wt % or more, or 70 wt % or more, or 80 wt % or more, or 90 wt % or more, or 95 wt % or more, based on the total weight of all the hexanedioate plasticizers. In one embodiment, the one or more hexanedioate plasticizers is dibenzyl hexanedioate.

In certain embodiments, for any of the embodiments described herein, the one or more hexanedioate plasticizers can comprise bis[2-(2-methoxyethoxy)ethyl] hexanedioate, dibenzyl hexanedioate, or combinations thereof. In certain embodiments, for any of the embodiments described herein, the one or more hexanedioate plasticizers comprise bis [2-(2-methoxyethoxy)ethyl] hexanedioate and dibenzyl hexanedioate in a combined amount of 50 wt % or more, or 60 wt % or more, or 70 wt % or more, or 80 wt % or more, or 90 wt % or more, or 95 wt % or more, based on the total weight of all the hexanedioate plasticizers. In one embodiment, the one or more hexanedioate plasticizers is a combination of bis[2-(2-methoxyethoxy)ethyl] hexanedioate and dibenzyl hexanedioate.

In certain embodiments, the cellulose ester can be chosen from cellulose acetate containing from about 5 to about 45% by weight acetyl, based on the total weight of the polymer. In certain embodiments, the cellulose ester can be chosen from cellulose acetate containing from about 10 to about 40% by weight acetyl, based on the total weight of the polymer. In certain embodiments, the cellulose ester can be chosen from cellulose acetate containing from about 15 to about 40%, or 20 to 40%, or 25 to 40%, or 30 to 40%, or 35 to 40% by weight acetyl, based on the total weight of the polymer. In certain embodiments, a cellulose ester containing 5 to 45% by weight acetyl can be further modified with up to 20 wt % butyryl or propionyl or mixtures thereof.

### DETAILED DESCRIPTION

In one embodiment of the invention, a cellulose ester composition (useful for making ophthalmic articles) is provided comprising at least one cellulose ester and at least one hexanedioate plasticizer.

In embodiments, the cellulose ester utilized in this invention can be any cellulose ester having a sufficient content of salt or ester moieties of C₃ to C₁₀ acids, preferably acetate, propionate and/or butyrate moieties. Cellulose esters that can be used for the present invention generally comprise repeating units of the structure:

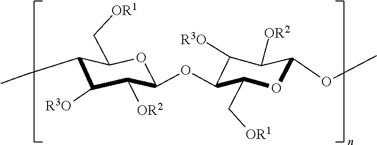

wherein R¹, R², and R³ are selected independently from the group consisting of hydrogen or straight chain alkanoyl having from 2 to 10 carbon atoms. For cellulose esters, the substitution level is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. However, low molecular weight cellulose mixed esters can have a total degree of substitution slightly above 3, as a result of end group contributions. Native cellulose is a large polysaccharide with a degree of polymerization from 250-5,000 even after pulping and purification, and thus the assumption that the maximum DS is 3.0 is approximately correct. However, as the degree of polymerization is lowered, as in low molecular weight cellulose mixed esters, the end groups of the polysaccharide backbone become relatively more significant, thereby resulting in a DS that can range in excess of 3.0. Low molecular weight cellulose mixed esters are discussed in more detail subsequently in this disclosure. Because DS is a statistical mean value, a value of 1 does not assure that every AGU has a single substituent. In some cases, there can be unsubstituted anhydroglucose units, some with two and some with three substituents, and typically the value will be a non-integer. Total DS is defined as the average number of all of substituents per anhydroglucose unit. The degree of substitution per AGU can also refer to a particular substituent, such as, for example, hydroxyl, acetyl, butyryl, or propionyl. In embodiments, the degree of polymerization for the cellulose ester is lower than that of the native cellulose. In embodiments, n is an integer in a range from 25 to 250, or 25 to 200, or 25 to 150, or 25 to 100, or 25 to 75.

In embodiments, the cellulose ester utilized can be a cellulose triester or a secondary cellulose ester. Examples of cellulose triesters include, but are not limited to, cellulose tripropionate or cellulose tributyrate. Examples of secondary cellulose esters include cellulose diacetate (or cellulose acetate), cellulose acetate propionate and cellulose acetate butyrate.

In one embodiment of the invention, the cellulose ester can be chosen from cellulose acetate (CA), cellulose propionate (CP), cellulose butyrate (CB), cellulose acetate propionate (CAP), cellulose acetate butyrate (CAB), cellulose propionate butyrate (CPB), cellulose acetate isobutyrate (CAIB), cellulose tripropionate (CTP), or cellulose tributyrate (CTB) and the like, or combinations thereof. Examples of some cellulose esters are described in U.S. Pat. Nos. 1,698,049; 1,683,347; 1,880,808; 1,880,560; 1,984,147, 2,129,052; and 3,617,201, incorporated herein by reference in their entirety to the extent that they do not contradict the statements herein. In one embodiment, the cellulose ester is CA.

In certain embodiments of the invention, the cellulose ester has a total percentage of acetyl by weight in the range from 5 to 45%, or 10 to 45%, or 15 to 45%, or 20 to 45%, or 25 to 45%, or 30 to 45%, or 35 to 45%, or 40 to 45%, or 5 to 40%, or 10 to 40%, or 15 to 40%, or 20 to 40%, or 25 to 40%, or 30 to 40%, or 35 to 40%, or 5 to 35%, or 10 to 35%, or 15 to 35%, or 20 to 35%, or 25 to 35%, or 30 to 35%, or 5 to 30%, or 10 to 30%, or 15 to 30%, or 20 to 30%, or 25 to 30%, or 5 to 25%, or 10 to 25%, or 15 to 25%, or 20 to 25%, based on the total weight of the cellulose ester polymer.

In certain embodiments of the invention, the cellulose ester has a total percentage of propionyl by weight in the range from 1 to 20%, or 1 to 15%, or 1 to 10%, or 1 to 5%, or 2 to 20%, or 2 to 15%, or 2 to 10%, or 2 to 5%, or 3 to 20%, or 3 to 15%, or 3 to 10%, or 3 to 5%, or 4 to 20%, or 4 to 15%, or 4 to 10%, or 5 to 20%, or 5 to 15%, or 5 to 10%, based on the total weight of the cellulose ester polymer.

In certain embodiments of the invention, the cellulose ester has a total percentage of butyryl by weight in the range from 1 to 20%, or 1 to 15%, or 1 to 10%, or 1 to 5%, or 2 to 20%, or 2 to 15%, or 2 to 10%, or 2 to 5%, or 3 to 20%, or 3 to 15%, or 3 to 10%, or 3 to 5%, or 4 to 20%, or 4 to 15%, or 4 to 10%, or 5 to 20%, or 5 to 15%, or 5 to 10%, based on the total weight of the cellulose ester polymer.

Cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three substituents selected independently from alkanoyls having from 2 to 10 carbon atoms. Examples of cellulose triesters include cellulose triacetate, cellulose tripropionate, and cellulose tributyrate or mixed triesters of cellulose such as cellulose acetate propionate, and cellulose acetate butyrate. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods can be used to yield cellulose esters that are useful in this invention.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

Some examples of cellulose esters s useful in various embodiments of the present invention can be prepared using techniques known in the art and can be obtained from Eastman Chemical Company, Kingsport, TN, U.S.A., e.g., Eastman™ Cellulose Acetate CA 398-10, Eastman™ Cellulose Acetate CA 398-30, and Eastman™ Cellulose Acetate LA150.

In certain embodiments, the cellulose ester is cellulose acetate (CA) having an acetyl content higher than 5%, based on the total weight of the CA polymer. In certain embodiments, the cellulose ester is cellulose acetate (CA) having an acetyl content less than about 40% based on the total weight of the CA polymer. In certain embodiments, the cellulose ester is a cellulose acetate that has a weight average molecular weight (Mw) in the range from 40,000 to 120,000, or 40,000 to 110,000, or 40,000 to 100,000, or 40,000 to 95,000, or 40,000 to 90,000, or 40,000 to 85,000, or 40,000 to 80,000, or 40,000 to 75,000, or 40,000 to 70,000, or 40,000 to 65,000, or 40,000 to 60,000, or 40,000 to 55,000, or 40,000 to 50,000, or 40,000 to 45,000, or 50,000 to 120,000, or 50,000 to 110,000, or 50,000 to 100,000, or 50,000 to 95,000, or 50,000 to 90,000, or 50,000 to 85,000, or 50,000 to 80,000, or 50,000 to 75,000, or 50,000 to 70,000, or 50,000 to 65,000, or 50,000 to 60,000, or 50,000 to 55,000, or 60,000 to 120,000, or 60,000 to 110,000, or 60,000 to 100,000, or 60,000 to 95,000, or 60,000 to 90,000, or 60,000 to 85,000, or 60,000 to 80,000, or 60,000 to 75,000, or 60,000 to 70,000, or 60,000 to 65,000, or 70,000 to 120,000, or 70,000 to 110,000, or 70,000 to 100,000, or 70,000 to 95,000, or 70,000 to 90,000, or 70,000 to 85,000, or 70,000 to 80,000, or 70,000 to 75,000, or 75,000 to 120,000, or 75,000 to 110,000, or 75,000 to 100,000, or 75,000 to 95,000, or 75,000 to 90,000, or 75,000 to 85,000, or 75,000 to 80,000, or 80,000 to 120,000, or 80,000 to 110,000, or 80,000 to 100,000, or 80,000 to 95,000, or 80,000 to 90,000, or 80,000 to 85,000, or 85,000 to 120,000, or 85,000 to 110,000, or 85,000 to 100,000, or 85,000 to 95,000, or 85,000 to 94,000, or 85,000 to 93,000, or 85,000 to 92,000, or 85,000 to 91,000, or 85,000 to 90,000, measured as described herein.

In certain embodiments, the cellulose ester is cellulose acetate propionate (CAP) having a propionyl content higher than 1%, based on the total weight of the CAP polymer. In certain embodiments, the cellulose ester is cellulose acetate propionate (CAP) having a propionyl content less than about 20% based on the total weight of the CAP polymer.

In certain embodiments, the cellulose ester is cellulose acetate butyrate (CAB) having a butyryl content higher than 1%, based on the total weight of the CAB polymer. In certain embodiments, the cellulose ester is cellulose acetate butyrate (CAB) having a butyryl content less than 20%, or less than 10%, based on the total weight of the CAB polymer.

In certain embodiments, the cellulose ester is cellulose acetate propionate butyrate, with the combined propionyl and butyryl content as a percentage of total weight of the polymer in the range from 1 to 20%, or 1 to 15%, or 1 to 10%, or 1 to 5%, or 2 to 20%, or 2 to 15%, or 2 to 10%, or 2 to 5%, or 3 to 20%, or 3 to 15%, or 3 to 10%, or 3 to 5%, or 4 to 20%, or 4 to 15%, or 4 to 10%, or 5 to 20%, or 5 to 15%, or 5 to 10%, based on the total weight of the cellulose ester.

Any of the cellulose esters discussed above can also contain up to 10% residual hydroxyl units, preferably 0.5% to 5%.

In embodiments of the invention, the hexanedioate plasticizer can include aliphatic and/or aromatic substituents. In embodiments, the hexanedioate plasticizer can be chosen from alkyl, alkyloxy and/or benzyl hexanedioates.

In certain embodiments, the composition contains at least one impact modifier, (optionally) at least one monomeric plasticizer in addition to the hexanedioate plasticizer, and the amount of the hexanedioate plasticizer in the cellulose ester composition is from 10 to less than 22 wt %, or 10 to 21 wt %, or 12 to 16 wt %, or 12 to 15 wt %, or 15 to less than 22 wt %, or 15 to 21 wt %, or 16 to less than 22 wt %, or 16 to 21 wt %, or 17 to less than 22 wt %, or 17 to 21 wt %, or 18 to less than 22 wt %, or 18 to 21 wt %, or 19 to less than 22 wt %, or 19 to 21 wt %, or greater than 19 to less than 22 wt %, or greater than 19 to 21 wt %, or 20 to less than 22 wt %, or 20 to 21 wt %, or greater than 20 to less than 22 wt %, or greater than 20 to 21 wt %, or 21 to less than 22 wt %, based on the total cellulose ester composition.

In one embodiment, one or more impact modifiers can be included with the hexanedioate plasticizer, and, in certain embodiments, the impact modifiers can be any polymeric material classified as an elastomer with a glass transition temperature (Tg) below room temperature. Tg can be measured for example according to ASTM D3418 using a TA 2100 Thermal Analyst Instrument using a scan rate of 20° C./min. Several classes of impact modifier fit this description.

In one embodiment, the impact modifier can be selected from the class of materials known as modified polyolefins (or olefin copolymers).

In one embodiment, the impact modifier can be a block copolymer in which at least one segment of the chain has a Tg below room temperature, referred to as the soft segment, and at least one segment of the chain has a Tg or Tm above room temperature, referred to as the hard segment. These block copolymers are also commonly referred to as thermoplastic elastomers (TPEs).

In one embodiment, the impact modifier can be selected from the class of emulsion-prepared materials known as core-shell impact modifiers. In one embodiment, the impact modifier is an MBS core-shell impact modifier.

In one embodiment of the present invention, the core shell impact modifier is an acrylic impact modifier. In one class of this embodiment, the impact modifier is an ABS core-shell impact modifier that has a core made out of butadiene-styrene copolymers and shell made out of acrylonitrile-styrene copolymer. In one class of this embodiment, the impact modifier is a silicone-acrylic core-shell impact modifier that has a core made out of silicone-acrylic rubber and shell made out of PMMA copolymer or methyl methacrylate-styrene copolymer.

In one embodiment, the impact modifier can be either a non-reactive impact modifier or a reactive impact modifier, or combination of both. The impact modifiers used can also improve mechanical and physical properties of the cellulose ester compositions.

In embodiments of the invention, the amount of impact modifier in the cellulose ester composition can range from about 1 wt % to about 15 wt %, or from 1 wt % to 10 wt %, or from 1 wt % to 5 wt %, or from 1 wt % to 4 wt %, or from 1 wt % to 3 wt %, or from 1 wt % to 2 wt %, or from about 2 wt % to about 10 wt %, or from 2 wt % to 5 wt %, or from about 3 wt % to about 10 wt %, or from 3 wt % to 5 wt %, or from about 4 wt % to about 10 wt %, or from about 4 wt % to about 8 wt %, or from about 5 wt % to about 10 wt %, based on the weight of the cellulose ester composition.

In one embodiment, the cellulose ester composition is transparent, with light transmission of at least 70%, or at least 75%, or at least 80%, or at least 85%, or at least 90%, measured according to ASTM D1003 using a 3.2 mm plaque after injection molding at a barrel set point of 249° C. and a residence time of 5 min. In certain embodiments, the polymer-based resin has transmission in the range from 70% to 95%, or 75% to 95%, or 80% to 95%, or 85% to 95%, or 90% to 95%, or 70% to 90%, or 75% to 90%, or 80% to 90%, or 85% to 90%, measured according to ASTM D1003 using a 3.2 mm plaque after injection molding at a barrel set point of 249° C. and a residence time of 5 min. In one class of this embodiment, the cellulose ester composition comprising the hexanedioate plasticizer has a percent haze of less than 10%. In embodiments, the cellulose ester composition comprising the hexanedioate plasticizer has a percent haze of less than 8%, or less than 6%, or less than 5%.

In embodiments, the composition contains at least one impact modifier and/or at least one monomeric plasticizer in addition to the hexanedioate plasticizer, and the amount of the hexanedioate plasticizer in the cellulose ester composition is from 10 to less than 19 wt %, or 10 to 18 wt %, or 10 to 17 wt %, or 10 to 16 wt %, or 10 to 15 wt %, or 10 to 14 wt %, or 10 to 13 wt %, or 10 to 12 wt %, or 11 to less than 19 wt %, or 11 to 18 wt %, or 11 to 17 wt %, or 11 to 16 wt %, or 11 to 15 wt %, or 12 to less than 19 wt %, or 12 to 18 wt %, or 12 to 17 wt %, or 12 to 16 wt %, or 12 to 15 wt %, or 13 to less than 19 wt %, or 13 to 18 wt %, or 13 to 17 wt %, or 13 to 16 wt %, or 13 to 15 wt %, or 14 to less than 19 wt %, or 14 to 18 wt %, or 14 to 17 wt %, or 14 to 16 wt %, or 14 to 15 wt %, or 15 to less than 19 wt %, or 15 to 18 wt %, or 15 to 17 wt %, or 15 to 16 wt %, or 16 to less than 19 wt %, or 16 to 18 wt %, or 16 to 17 wt %, or 17 to less than 19 wt %, or 17 to 18 wt %, or 18 to less than 19 wt %, based on the total cellulose ester composition.

In another embodiment of the invention, the cellulose ester compositions further comprise at least one additional polymeric component as a blend (with the cellulose ester) in an amount from 5 to 95 weight %, based on the total cellulose ester composition. Suitable examples of the additional polymeric component include, but are not limited to, nylon; polyesters; polyamides; polystyrene; other cellulose esters, cellulose ethers; polystyrene copolymers; styrene acrylonitrile copolymers; polyolephins; polyurethanes; acrylonitrile butadiene styrene copolymers; poly(methylmethacrylate); acrylic copolymers; poly(ether-imides); polyphenylene oxides; polyvinylchloride; polyphenylene sulfides; polyphenylene sulfide/sulfones; poly(ester-carbonates); polycarbonates; polysulfones; poly lactic acid; polysulfone ethers; and poly(ether-ketones) of aromatic dihydroxy compounds; or mixtures of any of the foregoing polymers. In embodiments, the additional polymeric component can be chosen from other cellulose esters, cellulose ethers, polyurethanes, poly lactic acids, or combinations thereof. In one embodiment, the additional polymeric component can be a polyurethane. The blends can be prepared by conventional processing techniques known in the art, such as melt blending or solution blending. In certain embodiments, the total amount of additional polymeric compounds is less than 25 wt %, or less than 20 wt %, or less than 15 wt %, or less than 10 wt %, or less than 5 wt %, or none, based on the total weight of the cellulose ester composition.

In one embodiment of the invention, in addition to the hexanedioate plasticizer, the composition can contain another monomeric plasticizer (other than the hexanedioate plasticizer). In embodiments, the monomeric plasticizer utilized in this invention can be any that is known in the art that can reduce the glass transition temperature and/or the melt viscosity of the cellulose ester to improve melt processing characteristics. The monomeric plasticizer may be any monomeric plasticizer suitable for use with a cellulose ester (that is added in addition to the hexanedioate plasticizer contained in the composition). In embodiments, the monomeric plasticizer level should be lower than the normal (or typical) monomeric plasticizer level utilized in conventional/commercial cellulose esters; so that the compositions have higher Tg than fully plasticized cellulose ester compositions, good toughness and good flow. In embodiments, the monomeric plasticizer is present in an amount that does not substantially reduce the Tg of the cellulose ester composition compared to a similar composition without the monomeric plasticizer. In embodiments, the Tg does not change (e.g., reduce) more than 20%, or 15%, or 10%, or 5%, or 2%, as a result of including the monomeric plasticizer.

In one embodiment, the monomeric plasticizer is at least one (other than a hexanedioate plasticizer) selected from the group consisting of an aromatic phosphate ester plasticizer, alkyl phosphate ester plasticizer, dialkylether diester plasticizer, tricarboxylic ester plasticizer, polymeric polyester plasticizer, polyglycol diester plasticizer, polyester resin plasticizer, aromatic diester plasticizer, aromatic triester plasticizer, aliphatic diester plasticizer, carbonate plasticizer, epoxidized ester plasticizer, epoxidized oil plasticizer, benzoate plasticizer, polyol benzoate plasticizer, adipate plasticizer, a phthalate plasticizer, a glycolic acid ester plasticizer, a citric acid ester plasticizer, a hydroxyl-functional plasticizer, or a solid, non-crystalline resin plasticizer.

In one embodiment of the invention, the monomeric plasticizer can be selected from at least one of the following: triphenyl phosphate, tricresyl phosphate, cresyldiphenyl phosphate, octyldiphenyl phosphate, diphenylbiphenyl phosphate, trioctyl phosphate, tributyl phosphate, diethyl phthalate, dimethoxyethyl phthalate, dimethyl phthalate, dioctyl phthalate, dibutyl phthalate, di-2-ethylhexyl phthalate, butylbenzyl phthalate, dibenzyl phthalate, butyl phthalyl butyl glycolate, ethyl phthalyl ethyl glycolate, methyl phthalyl ethyl glycolate, triethyl citrate, tri-n-butyl citrate, acetyltriethyl citrate, acetyl-tri-n-butyl citrate, and acetyl-tri-n-(2-ethylhexyl) citrate, diethylene glycol dibenzoate, dipropylene glycol dibenozoate, or triethylene glycol dibenzoate.

In another embodiment of the invention, the monomeric plasticizer can be selected from at least one (other than a hexanedioate plasticizer) of the following: esters comprising: (i) acid residues comprising one or more residues of: phthalic acid, adipic acid, trimellitic acid, succinic acid, benzoic acid, azelaic acid, terephthalic acid, isophthalic acid, butyric acid, glutaric acid, citric acid or phosphoric acid; and (ii) alcohol residues comprising one or more residues of an aliphatic, cycloaliphatic, or aromatic alcohol containing up to about 20 carbon atoms.

In another embodiment of the invention, the monomeric plasticizer can be selected from at least one (other than a hexanedioate plasticizer) of the following: esters comprising: (i) at least one acid residue selected from the group consisting of phthalic acid, adipic acid, trimellitic acid, succinic acid, benzoic acid, azelaic acid, terephthalic acid, isophthalic acid, butyric acid, glutaric acid, citric acid and phosphoric acid; and (ii) at least one alcohol residue selected from the group consisting of aliphatic, cycloaliphatic, and aromatic alcohol containing up to about 20 carbon atoms.

In another embodiment of the invention, the monomeric plasticizer can comprise alcohol residues where the alcohol residues is at least one selected from the following: stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol.

In another embodiment of the invention, the monomeric plasticizer can be selected from at least one of the following: benzoates, phthalates, phosphates, arylene-bis(diaryl phosphate), and isophthalates. In another embodiment, the monomeric plasticizer comprises diethylene glycol dibenzoate, abbreviated herein as “DEGDB”.

In another embodiment of the invention, the monomeric plasticizer can be chosen from aliphatic compounds (other than a hexanedioate plasticizer) comprising C₂-C₁₀ diacid residues, for example, malonic acid, succinic acid, glutaric acid, adipic acid, pimelic acid, suberic acid, azelaic acid, and sebacic acid; and C₂-C₁₀ diol residues.

In another embodiment, the monomeric plasticizer can comprise diol residues which can be residues of at least one of the following C₂-C₁₀ diols: ethylene glycol, diethylene glycol, 1,2-propylene glycol, 1,3-propylene glycol, 1,2-butylene glycol, 1,3-butylene glycol, 1,4-butylene glycol, neopentyl glycol, 1,5-pentanediol, 1,6 hexanediol, 1,5-pentylene glycol, triethylene glycol, and tetraethylene glycol.

In another embodiment of the invention, the monomeric plasticizer comprises at least one of the following: Resoflex® R296 plasticizer, Resoflex® 804 plastocizer, SHP (sorbitol hexapropionate), XPP(xylitol pentapropionate), XPA(xylitol pentaacetate), GPP(glucose pentaacetate), GPA (glucose pentapropionate) and APP (arabitol pentapropionate).

In another embodiment of the invention, the monomeric plasticizer comprises one or more of: A) from about 5 to about 95 weight % of a C₂-C₁₂ carbohydrate organic ester, wherein the carbohydrate comprises from about 1 to about 3 monosaccharide units; and B) from about 5 to about 95 weight % of a C₂-C₁₂ polyol ester, wherein the polyol is derived from a C₅ or C₆ carbohydrate. In one embodiment, the polyol ester does not comprise or contain a polyol acetate or polyol acetates.

In another embodiment, the monomeric plasticizer comprises at least one carbohydrate ester and the carbohydrate portion of the carbohydrate ester is derived from one or more compounds selected from the group consisting of glucose, galactose, mannose, xylose, arabinose, lactose, fructose, sorbose, sucrose, cellobiose, cellotriose and raffinose.

In another embodiment of the invention, the monomeric plasticizer comprises at least one carbohydrate ester and the carbohydrate portion of the carbohydrate ester comprises one or more of α-glucose pentaacetate, β-glucose pentaacetate, α-glucose pentapropionate, β-glucose pentapropionate, α-glucose pentabutyrate and β-glucose pentabutyrate.

In another embodiment, the monomeric plasticizer comprises at least one carbohydrate ester and the carbohydrate portion of the carbohydrate ester comprises an α-anomer, a β-anomer or a mixture thereof.

In another embodiment, the monomeric plasticizer can be selected from at least one of the following: propylene glycol dibenzoate, glyceryl tribenzoate, diethylene glycol dibenzoate, triethylene glycol dibenzoate, di propylene glycol dibenzoate, and polyethylene glycol dibenzoate.

In another embodiment of the invention, the monomeric plasticizer can be a solid, non-crystalline resin. These resins can contain some amount of aromatic or polar functionality and can lower the melt viscosity of the cellulose esters. In one embodiment of the invention, the monomeric plasticizer can be a solid, non-crystalline compound (resin), such as, for example, rosin; hydrogenated rosin; stabilized rosin, and their monofunctional alcohol esters or polyol esters; a modified rosin including, but not limited to, maleic- and phenol-modified rosins and their esters; terpene resins; phenol-modified terpene resins; coumarin-indene resins; phenolic resins; alkylphenol-acetylene resins; and phenol-formaldehyde resins.

In another embodiment of the invention, the monomeric plasticizer is at least one monomeric plasticizer selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, di-octyl adipate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, triethylene glycol bis-2-ethyl hexanoate glycerol esters, diethylene glycol, polypropylene glycol, polyglycoldiglycidyl ethers, dimethyl sulfoxide, N-methyl pyrollidinone, C₁-C₂₀ dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, diethylene glycol dibenzoate, dipropylene glycol dibenozoate, triethylene glycol dibenzoate, butylated hydroxytoluene, butylated hydroxyanisol, sorbitol, xylitol, ethylene diamine, piperidine, piperazine, hexamethylene diamine, triazine, triazole, pyrrole, and any combination thereof.

In embodiments, the amount of monomeric plasticizer (other than a hexanedioate plasticizer) in the cellulose ester composition can range from an amount greater than 0 to about 10 weight percent based on the weight of the cellulose ester composition, e.g., depending on the type of cellulose ester employed. In one embodiment, the amount can range up to about 10 weight percent based on the weight of the cellulose ester composition. In another embodiment, the amount can range up to about 9 weight percent based on the weight of the cellulose ester composition. In another embodiment, the amount can range up to about 8 weight percent based on the weight of the cellulose ester composition. In another embodiment, the amount can range up to about 7 weight percent based on the weight of the cellulose ester composition. In another embodiment, the amount can range up to about 6 weight percent based on the weight of the cellulose ester composition. In another embodiment, the amount can range up to about 5 weight percent based on the weight of the cellulose ester composition, or an amount less than 5 weight percent, or up to about 4 weight percent, or less than about 3 weight percent, based on the weight of the cellulose ester composition.

In an embodiment of the invention, the cellulose ester composition can further comprise a plasticizer (in addition to the monomeric plasticizer or in place of the monomeric plasticizer) chosen from one or more polyglycols, such as, for example, polyethylene glycol, polypropylene glycol, and polybutylene glycol. These can range from low molecular weight dimers and trimers to high molecular weight oligomers and polymers. In one embodiment, the molecular weight, weight average (Mw), of the polyglycol can range from about 200 to about 2000.

In embodiments, it should be understood that the cellulose ester composition can contain a material that falls within a category of materials that is generally known as or described herein as a monomeric plasticizer, but that is not considered to be a monomeric plasticizer for purposes of this invention provided that the material is of a specific type or included in an amount that provides (or contributes to) other functionality (other than plasticizer functionality), but that has minimal effect on lowering Tg or reducing melt flow viscosity, e.g., less than 1% or less than 0.5% change in such properties. For example, an epoxidized soy bean oil may be added in small amounts (e.g., 1 wt % or less, based on the composition) to provide other functionality, e.g., act as an acid scavenger, and, although epoxidized oil or epoxidized soy bean oil can generally be categories of monomeric plasticizers, such a material shall not be considered to be a monomeric plasticizer (if it is free of other materials that would act as a plasticizer) and shall be excluded from the specified ranges of monomeric plasticizer (according to various embodiments disclosed herein).

In embodiments, the composition contains from 0 to 2 wt %, or 0 to 1.5 wt %, or 0 to 1 wt %, of a fatty acid ester. In embodiments, the composition contains from 0 to 2 wt %, or 0 to 1.5 wt %, or 0 to 1 wt %, of an epoxidized fatty acid ester, e.g., epoxidized soy bean oil. In embodiments, the composition contains from 0.1 to 2 wt %, or 0.1 to 1.5 wt %, or 0.1 to 1 wt %, of an epoxidized fatty acid ester. In embodiments, the composition contains from 0.1 to 2 wt %, or 0.1 to 1.5 wt %, or 0.1 to 1 wt %, of an epoxidized soy bean oil. In embodiments, the composition contains from 0.1 to 2 wt %, or 0.1 to 1.5 wt %, or 0.1 to 1 wt %, of an epoxidized fatty acid ester and contains less than 5 wt % of any other monomeric plasticizer. In embodiments, the composition contains from 0.1 to 2 wt %, or 0.1 to 1.5 wt %, or 0.1 to 1 wt %, of an epoxidized soy bean oil and contains less than 5 wt % of any other monomeric plasticizer.

In certain embodiments, the cellulose ester composition comprises 58-85 wt % of one or more cellulose esters, 10 to less than 22 wt % of one or more hexanedioate plasticizer, 0-15 wt % of one or more impact modifiers, 0-10 wt % of at least one monomeric plasticizer, and less than 10 wt %, or less than 5 wt %, total of other components, based on the total weight of the cellulose ester composition.

In embodiments, the cellulose ester is CA (e.g., CA 398-30 from Eastman) and the hexanedioate plasticizer is a combination of two or more hexanedioate compounds (e.g., Daifatty-101 from Daihachi). In embodiments, the cellulose ester composition can further include a monomeric plasticizer, e.g., di-ethyl phthalate (DEP), where the total amount of the monomeric plasticizer is an amount 10 wt % or less, or less than 10 wt % (e.g., from 2 to less than 9 wt %, or 3 to less than 9 wt %, or 4 to less than 9 wt %, or 5 to less than 9 wt %, or 6 to less than 9 wt %, or 7 to less than 9 wt %, or 8 to less than 9 wt %) based on the total cellulose ester composition. In embodiments, the hexanedioate plasticizer, impact modifier (if present), and monomeric plasticizer (if present) are present in an amount sufficient to provide a cellulose ester composition having a Tg of at least 110° C., or at least 120° ° C., good impact strength properties, and good creep (resistance to deflection under load).

In another embodiment of the invention, the composition is melt processable. Melt processability generally refers to the ability to thermally process the materials below their degradation temperature to obtain homogeneous pellets or plastic articles. For example, the compositions described can be melt extruded on a Werner & Pflerderer 30 mm twin screw extruder at a throughput of 35 lbs/hour with screw speed of 250 rpm and barrel temperature of 240° C. and/or injection molded on a Toyo 110 injection molding machine with barrel temperature of 240° C. and mold temperature of 160° F. with minimal molecular weight degradation (e.g., less than 5% decrease in MW from the initial MW) or color degradation (e.g., less than 5% increase in haze or 5% decrease in transmission, based on a scale or 0 to 100%).

In one embodiment of this invention, a melt processable cellulose ester composition is provided comprising 10 wt % to less than 22 wt %, or 15 wt % to less than 22 wt %, or 19 wt % to less than 22 wt %, or greater than 19 wt % to less than 22 wt %, or 20 wt % to less than 22 wt %, or greater than 20 wt % to less than 22 wt % hexanedioate plasticizer, and a glass transition temperature (Tg) of at least 120° C. (measured at 20ºC/min according to ASTM D3418 as described further herein), and notched Izod impact strength value of greater than 150, or 180, or 200 J/m (measured according to ASTM D256 on 3.2 mm thick bars at 23ºC), and creep deflection of 10 mm or less when measured using the procedure described herein. Unless specified otherwise, Notched Izod Impact Strength was performed on molded bars after notching according to ASTM Method D256 after conditioning at 23° C. and 50% RH for 48 hours, on 3.2 mm thick bars at 23° C.

In one embodiment, in addition to the hexanedioate plasticizer, the melt processable cellulose ester compositions may comprise greater than 0 to 15 wt % of impact modifiers, greater than 0 to 10 wt % of monomeric plasticizers, and have a Tg greater than 120° C. In one embodiment, the impact modifier is a core-shell impact modifier. In one embodiment, the impact modifier is an acrylic core shell impact modifier.

In embodiments of the invention, the polymer-based resin has a Tg greater than 100° C., or greater than 110° C., or greater than 120° C.

In embodiments of the invention, the polymer-based resin has a notched izod impact strength of at least 130 J/m, or at least 140 J/m, or at least 150 J/m, or at least 160 J/m, or at least 170 J/m, or at least 180 J/m, or at least 190 J/m, or at least 200 J/m, as measured according to ASTM D256 using a 3.2 mm thick bar that has been subjected to 50% relative humidity for 48 hours at 23° C. In certain embodiments, the polymer-based resin has a notched izod impact strength in the range of from about 130 J/m to about 200 J/m, from about 150 J/m to about 200 J/m, from about 170 J/m to about 200 J/m, from about 180 J/m to about 200 J/m, as measured according to ASTM D256 using a 3.2 mm thick bar that has been subjected to 50% relative humidity for 48 hours at 23° C.

In certain embodiments of the invention, 3.2 mm thick plaques of the polymer-based resin exhibit ductile failure as defined in section X1.8 of ASTM D3763 when tested by instrumented impact according to ASTM D3763.

In embodiments of the invention, the polymer-based resin has a flexural modulus of greater than 1600 MPa as measured according to ASTM D790 using a 3.2 mm thick bar that has been subjected to 50% relative humidity for 48 hours at 23° C. In certain embodiments, the polymer-based resin has a flexural modulus of at least 1700, at least 1800, at least 1900 MPa, at least 2000 MPa, at least 2100 MPa, at least 2200 MPa, at least 2300 MPa, or at least 2400 MPa, as measured according to ASTM D790 using a 3.2 mm thick bar that has been subjected to 50% relative humidity for 48 hours at 23° C. In certain embodiments, the polymer-based resin has a flexural modulus is in the range of from about 1600 to about 3000 MPa, from about 1700 to about 3000, from about 1800 to about 3000, from about 1900 to about 3000 MPa, from about 2000 to about 3000 MPa, from about 2100 to about 3000 MPa, from about 2200 to about 3000 MPa, from about 2300 to about 3000 MPa, from about 2400 to about 3000 MPa, or from about 2500 to about 3000 MPa, as measured according to ASTM D790 using a 3.2 mm thick bar that has been subjected to 50% relative humidity for 48 hours at 23° C. In certain embodiments, the polymer-based resin has a flexural modulus is in the range of from about 1600 to about 2500 MPa, from about 1700 to about 2500 MPa, from about 1700 to about 2500 MPa, from about 1900 to about 2500 MPa, from about 1900 to about 2800 MPa, or from about 1900 to about 3000 MPa, as measured according to ASTM D790 using a 3.2 mm thick bar that has been subjected to 50% relative humidity for 48 hours at 23° C.

In certain embodiments of the invention, the cellulose ester compositions contain 10 wt %-less than 22 wt % hexanedioate plasticizer, based on the total weight of the cellulose ester composition, have Tg values greater than 120° C., notched Izod impact strength values greater than 150, or 160, or 170, or 180, or 190, or 200 J/m, and a light transmission value greater than 80%, or at least 85%, or at least 90%, measured according to ASTM D1003 using a 3.2 mm plaque after injection molding at a barrel set point of 249° C. and a residence time of 5 min.

In certain embodiments of the invention, 3.2 mm thick plaques of the cellulose ester compositions containing 10 wt %-less than 22 wt % hexanedioate plasticizer, based on the total weight of the cellulose ester composition, exhibit ductile failure as defined in section X1.8 of ASTM D3763 when tested by instrumented impact according to ASTM D3763, and have Tg values greater than 120° C.

In another embodiment of the invention, the cellulose ester compositions further comprise at least one additive selected from the group comprising antioxidants, thermal stabilizers, mold release agents, antistatic agents, whitening agents, colorants, flow aids, processing aids, anti-fog additives, minerals, UV stabilizers, lubricants, chain extenders, nucleating agents, reinforcing fillers, wood or flour fillers, glass fiber, carbon fiber, flame retardants, dyes, pigments, colorants, additional resins and combinations thereof.

In certain embodiments, in addition to the hexanedioate plasticizer, (optional) impact modifier and (optional) monomeric plasticizer (discussed herein), the cellulose ester composition includes stabilizers selected from the group consisting of secondary antioxidants, acid scavengers, or a combination thereof. In certain embodiments, the cellulose ester composition includes a secondary antioxidant in the range from about 0.1 to about 0.8 wt % based on the total weight of the composition. In certain embodiments, the cellulose ester composition includes an acid scavenger in the range from about 0.2 to about 2.0 wt % based on the total weight of the composition. In one embodiment, the cellulose ester composition includes a secondary antioxidant in the range from about 0.1 to about 0.8 wt % and an acid scavenger in the range from about 0.2 to about 2.0 wt % based on the total weight of the composition. In one embodiment, the secondary antioxidant is 3,9-bis(2,4-di-tert-butylphenoxy)-2,4,8, 10-tetraoxa-3,9-diphosphaspiro[5.5]undecane. In one embodiment, the acid scavenger is an epoxidized fatty acid ester. In one embodiment, the cellulose ester composition further includes a salt stabilizer, for example in the range from about 0.1 to about 0.5 wt % based on the total weight of the composition. In one embodiment, other than the cellulose ester, hexanedioate plasticizer, and stabilizers (discussed herein), the cellulose ester composition contains a total of less than 10 wt %, or less than 8 wt %, or less than 5 wt %, or less than 2 wt %, of any other components, based on the total weight of the composition.

In another embodiment of this invention, a process for producing a cellulose ester composition is provided comprising: a) mixing at least one hexanedioate plasticizer, at least one cellulose ester (and optionally at least one impact modifier and/or monomeric plasticizer) for a sufficient time and temperature to disperse the hexanedioate plasticizer (and other optional components) to produce the cellulose ester composition. A sufficient temperature is defined as the flow temperature of the cellulose ester which is generally about 50° C. above the Tg of the cellulose ester. In another embodiment, the temperature is about 80° C. above the Tg of the cellulose ester.

In embodiments, mixing of the hexanedioate plasticizer, cellulose esters (and optional impact modifiers and monomeric plasticizers and any additives) can be accomplished by any method known in the art that is adequate to disperse the components into the cellulose esters. Examples of mixing equipment include, but are not limited to, Banbury mixers, Brabender mixers, roll mills, and extruders (single or twin screw). The shear energy during the mixing is dependent on the combination of equipment, blade design, rotation speed (rpm), and mixing time. The shear energy should be sufficient to disperse the hexanedioate plasticizer and optional additional components throughout the cellulose ester.

The compositions of this invention are useful as molded plastic parts or as solid plastic objects for ophthalmic applications. Examples of such parts include eyeglass frames. In one embodiment, the compositions of the present invention can first be formed into films or sheets, and then formed or cut into ophthalmic articles, such as ophthalmic lenses and/or frames. It is believed that the unique combination of increased toughness and elevated HDT (and/or low creep deflection) as described herein vastly improves the ability of these ophthalmic articles (e.g., frame articles) to experience high-temperature environments (i.e., sun exposure), resist creep and warpage during hot warehouse storage, or during use in applications under moderate load or stress, and prevent loss in dimensional stability during use.

The methods of forming the cellulose ester compositions into film(s) and/or sheet(s) can include known methods in the art. Examples of film(s) and/or sheet(s) of the invention including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, wet block processing, dry block processing and solution casting.

The invention further relates to the molded articles described herein. The methods of forming the cellulose ester compositions into molded articles can include known methods in the art. Examples of molded articles of the invention including but not limited to injection molded articles, extrusion molded articles, and compression molded articles. Methods of making molded articles include but are not limited to injection molding, extrusion, and compression molding.

In embodiments, certain cellulose ester compositions are particularly useful for injection molded articles that are susceptible to gate or weld line induced impact (or stress) failure, e.g., injection molded articles having relatively thin sections/regions near the gate or weld line location of the mold, where an increased stress concentration occurs at (or near) the gate or weld line location of the molded article, such as eyeglass frames.

This invention can be further illustrated by the following examples of preferred embodiments thereof, although it will be understood that these examples are included merely for purposes of illustration and are not intended to limit the scope of the invention unless otherwise specifically indicated.

### EXAMPLES

Cellulose ester compositions were prepared by compounding selected cellulose ester with hexanedioate plasticizer and (optionally) monomeric plasticizers. Unless otherwise specified, the compounding of the cellulose ester compositions was conducted on a Werner & Pfleiderer 30-mm twin-screw extruder, at a throughput of 25 lbs/hour, with a screw speed of 250 RPM, and a barrel temperature of 220° C. The cellulose ester grade used in the following examples was CA 398-30 from Eastman (CA 1). The hexanedioate plasticizer (Pz1) used in the examples was Daifatty-101 from Daihachi.

The examples include testing on injection molded plaques and bars, and bars cut from compression molded sheets. Unless otherwise specified, the moldings were done on a Toyo injection molding machine with barrel temperature of 240° C. (460ºF) and mold temperature of 70° C. (160ºF). The sheet samples were compression molded at 204° C. (400° F.) and at 10 MPa. Unless otherwise specified, polymer molecular weight, plasticizer content, Tg, Haze, Light Transmission, Clarity, Melt Viscosity, Notched Izod Impact Strength, and creep resistance were measured/determined as discussed below.

Polymer molecular weight (Mw) was confirmed using a gel permeation chromatography (GPC) method, utilizing tetrahydrofuran (THF) and N-methyl-2-pyrrolidone (NMP) solvent systems, separately.

Plasticizer contents in the samples were confirmed using a gasO chromatographic (GC) method, utilizing a Shimadzu gas chromatograph equipped with a heated split injector, a DB-5 capillary column, and a flame ionization detector for separation and quantification.

Glass transition temperature (Tg) was measured according to ASTM Standard Method D3418, where the sample is heated from −100° C. at a heating rate of 20° C./min. DSC scans of blends of materials may show multiple Tg transitions. If more than one Tg transition was determined during the scan, the matrix glass transition is defined as the highest Tg measured during the scan.

Percent Haze and Light Transmission were measured on 102 mm×102 mm×3.2 mm injection molded plaques according to ASTM D1003. In the examples, where a clarity grading was provided, the grading was determined by visual inspection, where a grading of clear corresponds to a % haze of less than about 10%, a grading of slight haze corresponds to a % haze greater than about 10%, or greater than about 15%, and less than about 25%, and a grading of haze or hazy corresponds to a % haze greater than about 25%.

Melt Viscosity was measured using a Rheometric Dynamic Analyzer (RDA II) plate-plate melt rheometer with 25 mm diameter parallel plates, 1 mm gap and 10% strain measured in accordance with ASTM D4440 using frequency scan of between 1 rad/sec and 100 rad/sec.

Notched Izod Impact Strength was performed on 3.2 mm thick molded bars at 23° C. after notching according to ASTM Method D256, after conditioning the bars at 23° C. and 50% RH for 48 hours.

Creep resistance as used herein refers to a direct measurement of the dimensional stability of a material. Creep resistance was measured by placing bars atop an analysis jig in a 60° C. oven, with a 500-psi loading (˜295 g) applied directly to the center of the bar. Samples were left in the oven for 168 hours. The deflection remaining in the bar after the test (relative to a straight bar) was the measured creep deflection. The test bars used (in the creep resistance test) were either molded or cut from a sheet and had the following dimensions: L=12.7 cm (5.000″), W=1.27 cm (0.500″) and T=0.3175 cm (0.125″). The analysis jig supported the test bars near the ends of the bars with the bar ends spanning equally spaced over a test jig opening of 10.16 cm (4.0 inches) and the 295 g weight applied to the center of the bar.

Flex modulus was measured via ASTM D790 test method. Standard ASTM D790 type specimens were prepared as follows: 3.175 mm (⅛ in.) thick, 12.7 mm (0.5 in.) wide, and 130 mm (5 in.) long. Prior to testing, samples were conditioned at a temperature of 73±2° F. and relative humidity of 50±5% for 40 hours, according to ASTM D618 “Standard Practice for Conditioning Plastics for Testing”. Bluehill 3.51 and TestMaster 2.0.7 Software was used for programming operation of an Instron test frame. Five specimens were tested for each sample to obtain an average value. The samples were tested at a span of 2 inches, with a speed of 0.05 inches/minute. Each sample was flexed to 5.5% strain.

Heat Deflection Temperature (HDT) was analyzed under flexural load, in edgewise position, as per ASTM D 648 (0.25 mm/0.01 inch). The temperature was measured at point where the flex bar reaches a defined deformation (flexural HDT at 0.25 mm) under a specified load (“Low-Pressure” 0.46 MPa or 66 PSI, or “High-Pressure” 1.82 MPa or 264 PSI). Testing was performed during controlled heating conditions of 2° C./min. Specimen size was as follows: Flex bar having dimensions of 127 mm (5 in.) length, 13 mm (½ in.) in depth, and width from 3 mm (⅛ in.) to 13 mm (½ in.).

### Example 1—CA with Hexanedioate Plasticizer and DEP Plasticizer

CA1 with Pz1 (Ex. 1-1 to 1-4), with a combination Pz1 and DEP plasticizer (Ex. 1-5 and 1-6) and with DEP plasticizer (Ex. 1-7 and 1-8) were each injection molded into 12.7×1.27×0.3175 cm bars.

The creep deflection, notched izod impact, and flexural modulus were determined for each sample. The compositions and properties of the materials for Examples 1-1 to 1-8 are listed below in table 1.

TABLE 1
Creep Deflection, Notched Izod, and Flexural Modulus
for CA materials with different plasticizer.

| | | Creep | | |
|---|---|---|---|---|
| | | Deflection | Notched Izod | Flex. Mod. |
| Example | Pz/Wt % | (mm) | (J/m) | (MPa) |
| 1-1 | Pz1 (16%) | 3.44 | 112.5 | 2979 |
| 1-2 | Pz1 (19%) | 6.49 | 133.4 | 2539 |
| 1-3 | Pz1 (22%) | 11.31 | 212.5 | 2114 |
| 1-4 | Pz1 (25%) | >25.00 | 350.7 | 1707 |
| 1-5 | Pz1 (15%) + | 15.36 | 220.7 | 1962 |
| | DEP (10%) | | | |
| 1-6 | Pz1 (15%) + | 5.66 | 131.8 | 2623 |
| | DEP (5%) | | | |
| 1-7 | DEP (21%) | 4.41 | 114.5 | 2730 |
| 1-8 | DEP (28%) | >25.00 | 200.5 | 1784 |

### Example 2—CA with Hexanedioate Plasticizer and DEP Plasticizer

CA1 with Pz1 (Ex. 2-1 to 2-4) and with DEP plasticizer (Ex. 2-5 and 2-6) were each injection molded into 12.7×1.27×0.3175 cm bars.

The Mw, notched izod impact, flexural modulus, HDT (low and high press.), and Tg were determined for each sample. The compositions and properties of the materials for Examples 2-1 to 2-6 are listed below in table 2.

TABLE 2
Notched Izod, Flexural Modulus, HDT and Tg for CA materials with different plasticizer.

| | | Mw of CA1 | Notched Izod | Flex. Mod. | LoHDT | HiHDT | Tg |
|---|---|---|---|---|---|---|---|
| Example | Pz/Wt % | (THF) | (J/m) | (MPa) | (° C.) | (° C) | (° C.) |
| 2-1 | Pz1 | 86583 | 141.8 | 2727 | 107.4 | 94.1 | 125.7 |
| | (16%) | | | | | | |
| 2-2 | Pz1 | 86672 | 183.6 | 2368 | 98.7 | 89.6 | 119.7 |
| | (20%) | | | | | | |
| 2-3 | Pz1 | 88683 | 182.2 | 2197 | 91.9 | 85.4 | 122.0 |
| | (22%) | | | | | | |
| 2-4 | Pz1 | 87307 | 203.1 | 1839 | 93.0 | 86.0 | |
| | (24%) | | | | | | |
| 2-5 | DEP | 91539 | 181.0 | 2430 | 92.6 | 85.5 | 115.6 |
| | (21%) | | | | | | |
| 2-6 | DEP | 89915 | 172.4 | 1784 | 86.5 | 80.3 | 120.1 |
| | (27%) | | | | | | |

A review of the examples reveals that the combination of CA1 and Pz1 (or Pz1+DEP), in certain amounts, can provide molded articles having a combination of high Tg, high notched izod and high LoHDT and/or low creep deflection, which is important for ophthalmic applications. The compositions with 28 wt % DEP had unacceptably high creep deflection and compositions with 21 wt % DEP had unacceptable toughness performance.

The above detailed description of embodiments of the disclosure is intended to describe various aspects of the invention in sufficient detail to enable those skilled in the art to practice the invention. Other embodiments can be utilized, and changes can be made without departing from the scope of the invention. The above detailed description is, therefore, not to be taken in a limiting sense. The scope of the present invention is defined only by claims presented in subsequent regular utility applications, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, step, etc. described in one embodiment may also be included in other embodiments, but is not necessarily included. Thus, the present technology can include a variety of combinations and/or integrations of the embodiments described herein.

1. An ophthalmic article comprising a cellulose ester composition, said cellulose ester composition comprising at least one cellulose ester and at least one hexanedioate plasticizer,
wherein said at least one cellulose ester is chosen from cellulose acetate (CA), cellulose propionate (CP), cellulose butyrate (CB), cellulose acetate propionate (CAP), cellulose acetate butyrate (CAB), cellulose propionate butyrate (CPB), cellulose tripropionate (CTP), or cellulose tributyrate (CTB);
wherein the at least one hexanedioate plasticizer is present in an amount from 10 to less than 22 wt %, based on the total weight of the cellulose ester composition;
wherein said cellulose ester composition has a Tg of at least 120° C., a notched Izod impact strength of at least 150 J/m, measured according to ASTM Method D256 at 23° C. using a 3.2 mm bar, after conditioning the bar at 23° C. and 50% RH for 48 hours, and a creep deflection less than 10 mm, measured as described in the specification.

2. The ophthalmic article according to claim 1, wherein said cellulose ester composition comprises at least one hexanedioate plasticizer in an amount from 19 to less than 22 wt % and comprises 0 to 1 wt % of any other plasticizers, based on the total weight of the cellulose ester composition.

3. The ophthalmic article according to claim 1, wherein said cellulose ester composition comprises at least one hexanedioate plasticizer in an amount from 10 to less than 19 wt % and comprises at least one monomeric plasticizer in an amount from 2 to 10 wt %, based on the total weight of the cellulose ester composition.

4. The ophthalmic article according to claim 1, wherein said at least one cellulose acetate comprises a CA that has a degree of substitute of less than 2.5, or substitution in the range from 2.35 to less than 2.5.

5. The ophthalmic article according to claim 1, wherein said at least one hexanedioate plasticizer comprises a benzyl hexanedioate plasticizer.

6. The ophthalmic article according to claim 1, wherein said at least one hexanedioate plasticizer is chosen from benzyl 2-(2-methoxyethoxy)ethyl hexanedioate, bis[2-(2-methoxyethoxy)ethyl] hexanedioate, dibenzyl hexanedioate, and combinations thereof.

7. The ophthalmic article according to claim 1, wherein benzyl 2-(2-methoxyethoxy)ethyl hexanedioate is present in the cellulose ester composition in an amount from 0 to less than 50 wt %, based on the total weight of hexanedioate plasticizers.

8. The ophthalmic article according to claim 1, wherein said cellulose ester composition has a creep deflection of 8.0 mm of less.

9. The ophthalmic article according to claim 1, wherein said cellulose ester composition has a low pressure heat deflection temperature (LoHDT) of 90° C. or higher.

10. The ophthalmic article according to claim 3, wherein said cellulose ester composition comprises 12 to less than 16 wt % of said at least one hexanedioate plasticizer and 5 to 9 wt % of said at least one monomeric plasticizer.

11. The ophthalmic article according to claim 1, wherein the cellulose ester composition comprises at least one monomeric plasticizer chosen from DEP, a citrate based plasticizer, triacetin, or combinations thereof.

12. The ophthalmic article according to claim 1, wherein said cellulose ester composition has a Tg of at least 120° C., a notched Izod impact strength of at least 180 J/m, measured according to ASTM Method D256 at 23° C. using a 3.2 mm bar, after conditioning the bar at 23° C. and 50% RH for 48 hours, and a creep deflection less than 10.0 mm, measured as described in the specification.

13. The ophthalmic article according to claim 1, wherein said cellulose ester composition further comprises at least one additive selected from the group consisting of antioxidants, thermal stabilizers, mold release agents, antistatic agents, whitening agents, colorants, minerals, UV stabilizers, lubricants, nucleating agents, reinforcing fillers, glass fiber, carbon fiber, flame retardants, dyes, pigments, colorants, additional resins and combinations thereof.

14. The ophthalmic article according to claim 1, wherein the cellulose ester composition further comprises at least one polymeric component as a blend wherein said polymer is selected from the group consisting of other cellulose esters, cellulose ethers;
polyurethanes; poly lactic acid; and combinations thereof.

15. The ophthalmic article according to claim 1, wherein the ophthalmic article is chosen from an injection molded article, extrusion molded article, or a compression molded article.

16. The ophthalmic article according to claim 1, wherein the ophthalmic article is an eyeglass or sunglass frame.
